(19) United States
(12) Patent Application Publication
(10) Pub. No.: US 2004/0245170 A1
(43) Pub. Date: Dec. 9, 2004

(54) Water filter for cyst reduction

(76) Inventors: Tara L. Koele, Sheboygan, WI (US); Michael D. Steinhardt, Kiel, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/456,717

(22) Filed: Jun. 6, 2003

(51) Int. Cl. B01D 27/00

(52) U.S. Cl. 210/497.1; 210/266

(57) ABSTRACT

A composite water filter for reducing the cyst content for drinking water utilizing a non-woven microfiber layer prefilter wrapped over a porous carbon block filter to retain at least 99.95% of cyst-size particles while retaining a relatively low pressure drop and high flow rate.

### BACKGROUND OF THE INVENTION

The present invention relates to filters for the purification of drinking water and, more particularly, to the use of a pre-filter media with a carbon block filter element to remove cysts, permit the use of a less dense carbon block, and to improve flow rate and filter life.

Historically, carbon block filters, comprising carbon particles bonded under pressure, have provided a filtration media that has performed a multitude of tasks in the water treatment industry. Carbon block is used to reduce heavy metals, chlorine, volatile organic compounds, sediment, cryptosporidium, giardia and other protozoan cysts, and improve taste and odor. The block structure must be dense and composed of very small particles to remove cysts and therefore the resultant pressure drop across the block is very high for a given water flow rate. In addition, these high density blocks will tend to filter out all types of particulate matter present in the water with high filtration efficiency. This results in premature plugging of the block pores and more frequent filter changes.

### SUMMARY OF THE INVENTION

An improved dual stage filtration carbon block is disclosed that allows for reduced pressure drop while still maintaining the filtration efficiency to remove cysts. Recently, a class of filtration media has emerged that improves the filtration efficiency of particulate matter. This media is typically melt blown fiber or glass fiber deposited on or between spun bonded papers.

The present invention utilizes this media as a pre-filtration wrap around a carbon block. The resultant filter possesses properties unlike that of present production carbon block in that it filters and retains cysts and other small particles on the outer wrap and utilizes the carbon block inner core as the chemical filter. Current production blocks sometimes are constructed with a pre-filter wrap; however, the wrap that is utilized is only used for course sediment removal and to cover the block for aesthetic reasons. This invention utilizes a wrap specifically formulated for fine particle removal. The result of this invention is a true dual stage filter where the density of the carbon block and resultant pressure drop of the carbon block filter can be much lower than a block that is currently designed to remove cysts.

In a presently preferred embodiment, a high efficiency, low pressure drop water purification filter particularly adapted for cyst reduction includes an inner porous carbon block element that is made of bonded carbon particles having a nominal size range of about 40 microns to 600 microns and a block density in the range of about 0.3 gm/cm³ to 0.75 gm/cm³; and outer wrap utilizing a non-woven fiber layer that encloses the carbon block and is capable of retaining at least 99.95% of particles as small as 3 microns; and wherein the fiber layer is supported on the carbon block to prevent collapse and is sealed at the interface between the layer and the block at both axially opposite ends and along opposed enclosing edges of the layer.

The non-woven fiber layer may comprise glass fibers or melt blown plastic fibers of, for example, polypropylene. Preferably, the non-woven fiber layer is provided with a highly porous backing layer or layers to provide support and protection for the non-woven layer. The backing layer may comprise a spun bonded paper layer and the interface of the non-woven fiber layer with the carbon block may also be covered with a highly porous backing layer or the same or similar spun bonded paper layer.

### BRIEF DESCRIPTION OF THE DRAWINGS

FIG. 1 is a vertical sectional view through a water purification filter made in accordance with the present invention.

FIG. 2 is a graph showing net pressure drop versus flow rate comparing prior art filters with a filter of the present invention.

FIG. 3 is a graph showing flow rate versus inlet pressure and comparing the performance of prior art filters with filters of the present invention.

FIG. 4 is a graph showing the cyst reduction performance of prior art filters versus filters of the present invention.

FIG. 5 is a graph showing flow rate versus total flow volume in prior art filters and filters of the present invention operating to remove cysts.

### DETAILED DESCRIPTION OF THE PREFERRED EMBODIMENT

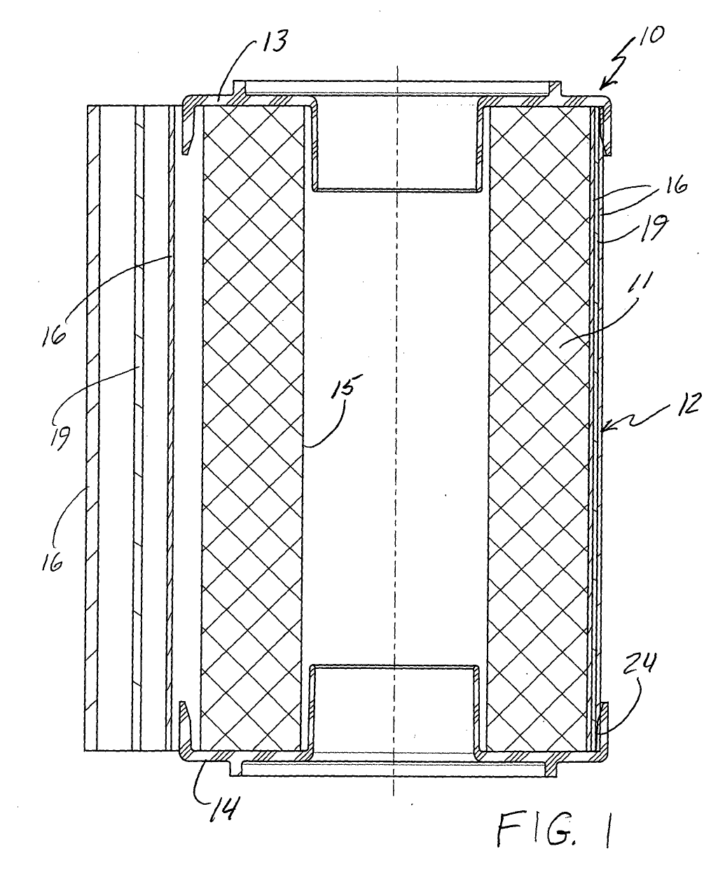

Referring to FIG. 1, a filter 10 made in accordance with the present invention includes a porous carbon block 11 surrounded by an outer wrap 12 which act together to provide a filter for high cyst removal capability and relatively low pressure drop. The carbon block 11 and outer wrap 12 are enclosed together in an upper end cap 13 and a lower end cap 14 so that radial flow of water to be filtered from the outside of the filter 10 to the inside of the carbon block 11 must pass first through the outer wrap 12 without by-pass. The filter 10 is typically sealed in the end caps 13 and 14 with a polyolefin hot melt adhesive 24. Similarly, the edges of the outer wrap 12 which includes a non-woven fiber layer 19, as will be described in greater detail, must be sealed with a butt joint or overlapping joint where the opposed edges of the outer wrap 12 meet. The sealed joint may utilize an adhesive or may comprise a heat seal. The filter 10 is of a type adapted to be placed in a hollow housing or sump (not shown) and enclosed with a housing cap (also not shown), the housing cap providing an inlet to the outside of the filter for untreated water and an outlet from the hollow interior 15 of the carbon block for filtered water all in a manner well known in the art.

The carbon block 11 is made from fine particulate carbon mixed with a suitable binder, such as polyethylene, and formed under heat and pressure into a solid porous block. Variations in the particle size and the formation conditions result in carbon blocks of varying density and porosity. In the porous blocks preferred for use in the present invention, the carbon particles are preferably in a size range of about 40 microns to about 600 microns and the formed carbon block has a density in the range of about 0.3 gm/cm³ to about 0.75 gm/cm³. Carbon blocks made in accordance with the foregoing specifications are generally considered to be unsuitable for cyst removal. However, the actual density of carbon blocks useful in this invention will vary quite widely depending on the type of the carbon (i.e. the density and size of the carbon particles) and other materials used in the construction of the block. The current applicable standard for cyst removal in a filter for domestic drinking water use requires removal of more than 99.95% of cysts, based on the nominal particle size as small as 3 microns. However, these carbon blocks are desirable nevertheless for their ability to remove other contaminants such as heavy metals, chlorine, VOCs and sediment while exhibiting a desirable low pressure drop.

In accordance with the present invention, a low density carbon block 11 is combined with an outer wrap 12 utilizing a non-woven fiber layer 19 that is capable of filtering and retaining at least 99.95% of particles as small as 3 microns. The combination of a pre-filter for cyst removal utilizing a non-woven fiber layer 19 as part of the outer wrap 12 and a low density carbon block 11 provides a unique combination that permits cyst removal at relatively low pressure drop and without premature clogging of the filter.

One particularly suitable non-woven fiber layer 19 is a micro-glass material made by Lydall, Inc. and sold under the trademark LYPORE. This material comprises a dense mat of extremely fine glass fibers (with a nominal diameter of about 1 μm) laid down in a mat having a thickness of 24 mils (0.6 mm) to provide a mean pore size of 2 microns. The fibers are held in the mat with an adhesive binder, such as EVA.

The outer wrap 12 may alternately include a non-woven fiber layer 19 comprising melt blown plastic fibers. Such a material may comprise, for example, polypropylene fibers with a nominal diameter of about 3 μm. The other physical properties of the non-woven plastic fiber layer are similar to those of the non-woven glass fiber layer. Both the non-woven glass fiber and non-woven plastic fiber layers 19 are typically laid on a backing layer 16 comprising a highly porous spun bonded paper. It is preferable to provide a similar backing layer 16 to the other side of the non-woven fiber layer 19 to protect the interface of the wrap 12 with the carbon block 11.

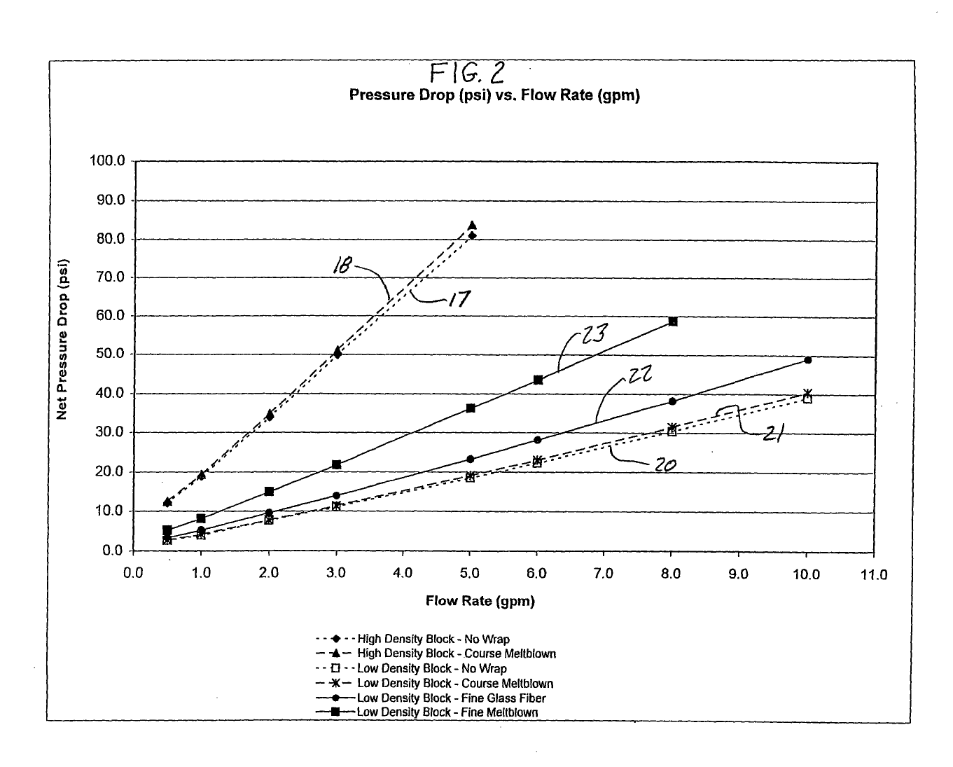

Referring now to FIGS. 2-5, the performance of filters 10 made in accordance with the present invention and utilizing either a glass fiber outer wrap or a fine melt blown plastic outer wrap 12 are compared with (1) similar carbon blocks with no wrap or a coarse fiber wrap, and (2) with high density blocks (suitable for cyst removal, but having a high pressure drop) having a coarse melt blown wrap or no wrap whatever. In each of the graphs of FIGS. 2-5, the various plots are numbered consistently to show a high density block with no wrap 17, a high density block with a coarse wrap (the wrap per se not capable of retaining cysts) 18, a low density block 20 with no outer wrap, a low density block 21 with a coarse outer wrap (the same wrap as filter 18), a low density block 22 of the present invention using a non-woven glass fiber layer 19 in the outer wrap 12, and a low density block 23 of the present invention having a fine melt blown micro-fiber layer 19 in the outer wrap 12.

The high density blocks 17 and 18 are outside the ranges of particle size and block density set forth above, whereas, the low density blocks 20-23 are all within those ranges.

Referring specifically to FIG. 2, the pressure drops through the high density blocks 17 and 18 are seen to be much higher than pressure drops across any of the low density blocks 20-23. The addition of a coarse melt blown outer wrap (not capable of retaining cysts) does not significantly increase the pressure drop of either the high density or low density blocks. The addition of the non-woven glass fiber layer 19 to the low density block 22 and the addition of the non-woven meltblown fiber layer 19 to the low density block 23 increases the pressure drop slightly, but the pressure drops remain significantly less than pressure drop across the high density blocks 17 and 18.

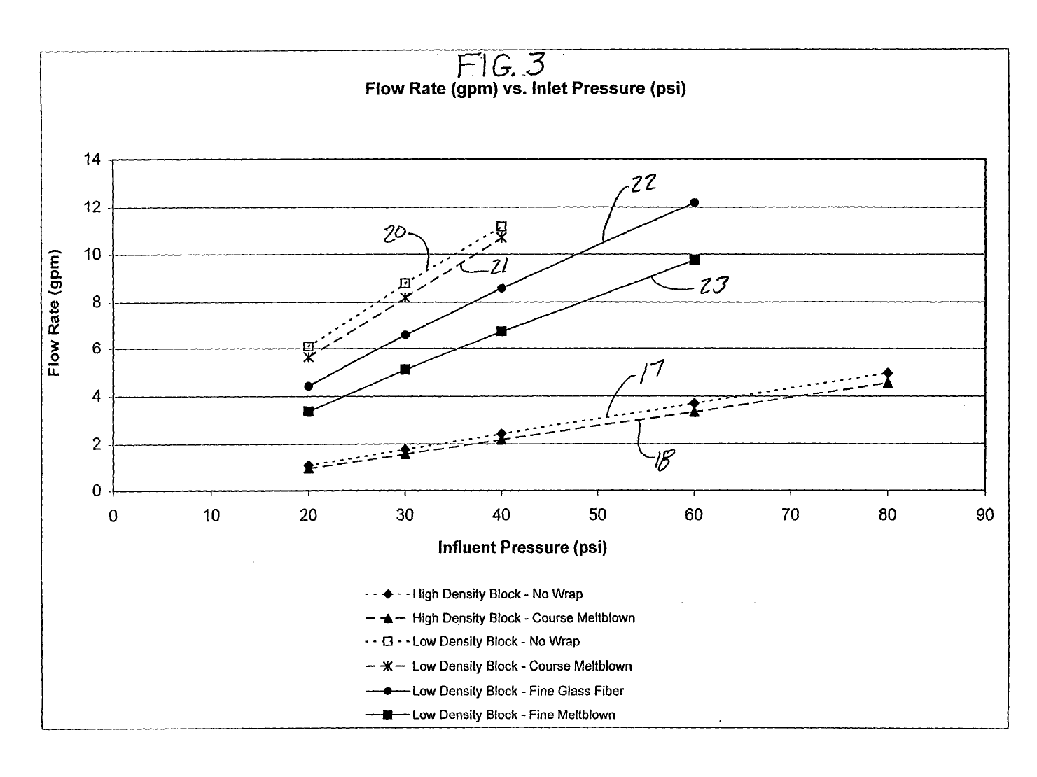

Referring to FIG. 3, both high density blocks 17 and 18 produce less than 2 gpm flow of water at 30 psi inlet pressure. The low density blocks 20 and 21 with no wrap and with a coarse wrap, respectively, produced over 8 gpm flow at 30 psi inlet pressure. The low density blocks 22 and 23, respectively, having the non-woven layers 19 of glass fibers and melt blown fibers of the present invention produced between 5 and 7 gpm at 30 psi pressure. These flow rates are only slightly lower than for the low density blocks with no wrap or coarse wrap, but substantially higher than either of the high density blocks 17 and 18.

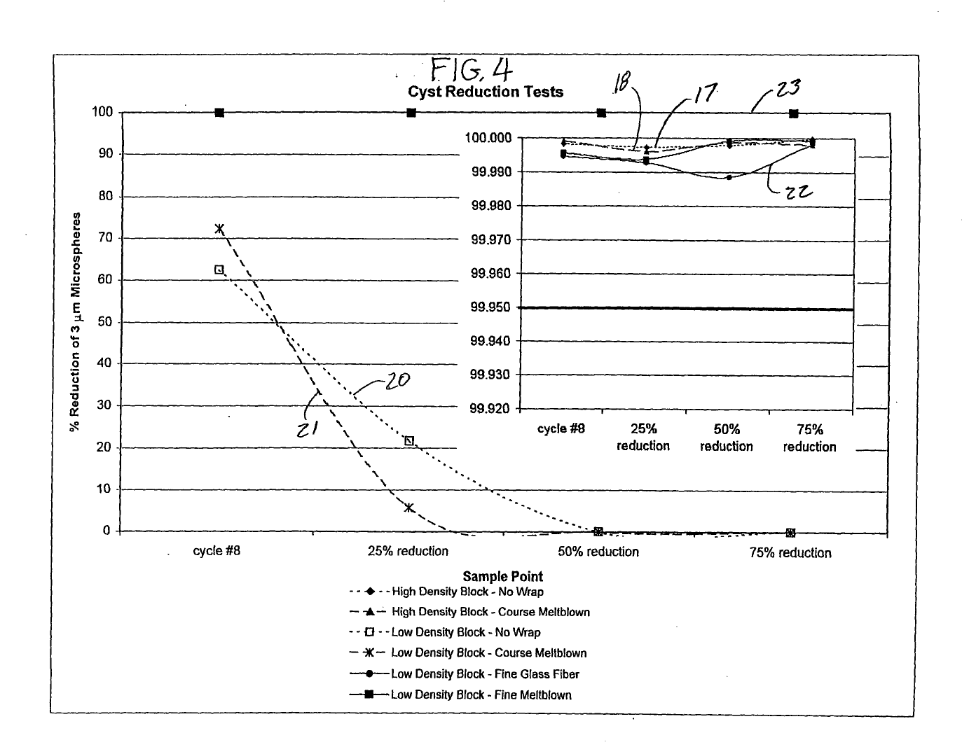

FIG. 4 shows the results of the cyst reduction tests for the same six filter blocks tested in the preceding FIGS. 2 and 3. For these tests, surrogate cysts comprising three micron latex microspheres were utilized. Both high density blocks 17 and 18 passed the cyst removal requirement of more than 99.95% removal, however, these dense blocks are specifically constructed for cyst removal as indicated above. The low density blocks 20 and 21 having, respectively, no wrap or a coarse wrap failed completely the cyst removal test. These blocks exhibited extremely poor performance that continued to degrade through the course of the tests from an initial reduction of 60%-75% to as low as 0%. By comparison, the low density block 22 with the fine non-woven glass fiber layer 19 and the low density block 23 with the fine melt blown non-woven plastic fiber layer 19 both passed the cyst removal test requirement of greater than 99.95% removal for all four sample points. These results show a very significant increase in performance over identical low density blocks 20 and 21 having no wrap or a very coarse melt blown wrap. These tests also show that a low density block 22 or 23 with an appropriate non-woven fiber layer 19 will provide essentially the same cyst removal performance as the high density blocks 17 and 18 but with a much lower pressure drop as shown in FIG. 2.

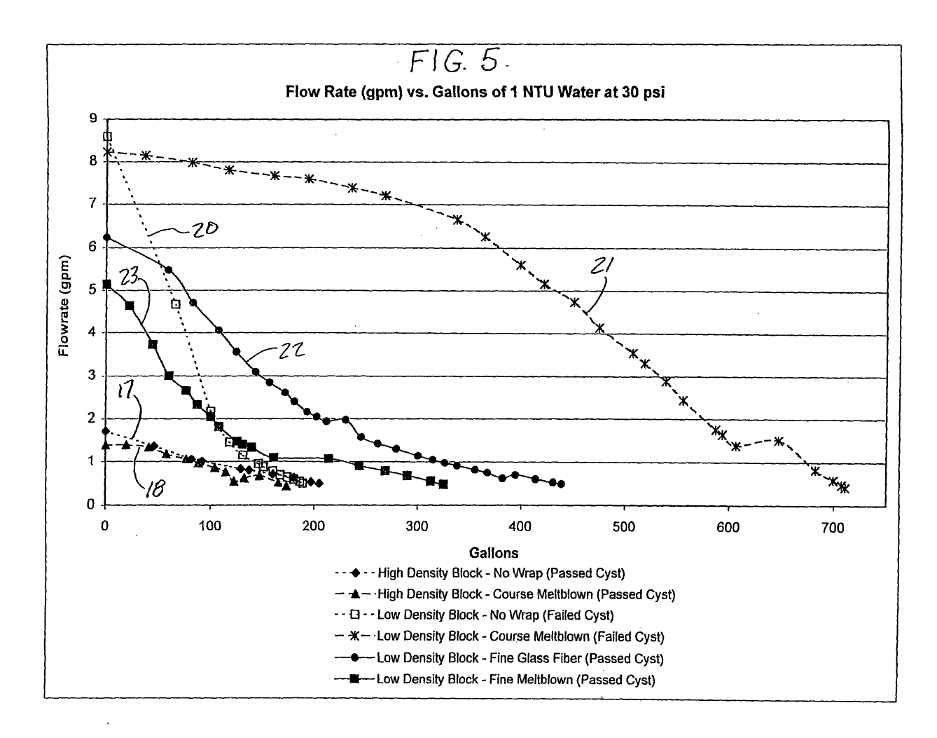

Referring now to FIG. 5, tests were run to compare the flow rate through the various filters with total filtered volume to determine how rapidly the filters plugged when operating to remove cysts. Both high density blocks 17 and 18 began with relatively low flow rates of 1-2 gpm and very quickly plugged to drop to a flow rate of 0.5 gpm after less than 200 gallons total flow. The low density block 20 with no outer wrap also plugged very quickly at less than 200 gallons total flow even though it began at a much higher flow rate of greater than 8 gpm. The low density block 21 with a coarse outer wrap also had a high initial flow rate of greater than 8 gpm, and performed best of all the filters tested and was able to process 700 gallons before plugging. This filter, however, has no cyst removal capability. Both low density blocks 22 and 23 utilizing the fine non-woven glass fiber layer or the fine meltblown non-woven plastic fiber layer of the present invention exhibited initial flow rates between 5 and 6.5 gpm and plugged at slightly more than 300 and 450 gallons total flow, respectively. Both of these filters 20 and 23, with cyst removal capability, performed much better than the high density cyst removal filters 17 and 18 which plugged at about only half the total flow.

We claim:

1. A high efficiency, low pressure drop water purification filter for cyst reduction comprising:
an inner porous carbon block element made of bonded carbon particles having a nominal size range of about 40 μm to 600 μm and a block density in a range of about 0.3 gm/cm³ to 0.75 gm/cm³;
an outer wrap comprising a non-woven fiber layer enclosing the carbon block and capable of retaining particles as small as 3 μm; and, said fiber layer supported on said carbon block to prevent collapse and sealed at the interface between the layer and the block at both axially opposite ends and along opposed enclosing edges of the layer.

2. The filter as set forth in claim 1 wherein said fiber layer comprises glass fibers.

3. The filter as set forth in claim 1 wherein said fiber layer comprises meltblow plastic fibers.

4. The filter as set forth in claim 1 wherein said porous carbon block element comprises a hollow cylindrical block.

5. The filter as set forth in claim 1 including a highly porous backing layer enclosing the fiber layer.

6. The filter as set forth in claim 5 wherein said backing layer comprises a spun bonded paper layer.

7. The filter as set forth in claim 1 wherein the fiber layer is covered on both faces with a highly porous backing layer comprising spun bonded paper layers.
